(19) United States
(12) Patent Application Publication
(10) Pub. No.: US 2005/0064266 A1
(43) Pub. Date: Mar. 24, 2005

(54) Modular fuel cell cartridge and stack

(76) Inventors: Mohamed Abdou, Kingston Ontario (CA); David King, Cherry Valley (CA); Tuyu Xie, Kingston Ontario (CA); Peter James Andrin, Napanee (CA)

Correspondence Address: Daphne P Fickes;E I Du Pont de Nemours & Company, Legal Patents, Wilmington, DE, 19898, US

(21) Appl. No.: 10/490,067

(22) PCT Filed: Sep. 17, 2002
(86) PCT No.: PCT/CA02/01418

Related U.S. Application Data
(60) Provisional application No. 60/323,061, filed on Sep. 18, 2001.

(51) Int. Cl. H01M 2/08; H01M 8/02; H01M 8/10

(52) U.S. Cl. 429/35; 429/38; 429/30

(57) ABSTRACT

A modular unitized electrochemical fuel cell cartridge (20) is formed from a mono-polar anode plate (22), a second mono-polar cathode plate (24 ) and a solid polymer membrane electrode assembly (26) operably interposed between the anode and the cathode. An electrochemical fuel cell stack is provided having at least one removable fuel cell cartridge, a pair of current collectors which are individually disposed on opposite sides of the anode and the cathode plates and a pair of end plates which are individually disposed on opposite sides of the current collectors from the anode and cathode plates. Sealing ridges (42) and mating grooves (44) as well as alignment means (46) enable the easy assembly of a modular unitized fuel cell cartridge and stacking said cartridge.

### FILED OF THE INVENTION

This invention relates to fuel cells stacks, and in particular to unitized electrochemical fuel cell stacks with mono-polar fuel cell cartridges.

### BACKGROUND OF THE INVENTION

Fuel cell technology, used for clean and efficient power generation, has made tremendous technical progress over the years. Most advances have been in the solid-oxide fuel cell (SOFC) and proton-exchange-membrane fuel cell (PEMFC). The growing acceptance of fuel cells for power generation is due to a number of benefits including low operating temperatures, non-corrosive and stable electrolyte, and broader market applications.

One of the major challenges facing fuel cell technology is whether the electrochemical fuel cell stacks can be designed and mass-produced cost-effectively. To reduce the cost of fuel cell stacks, it is necessary to develop low cost materials and develop new stack designs that allow for simple mass production at low cost.

Bipolar flow field plates are formed between the anode of one fuel cell and the cathode of a second fuel cell. This provides a flow field for both the oxidant and the fuel and also allows the electrons generated at the anode of one fuel cell to be conducted to the cathode of an adjacent cell.

Bipolar flow field plates are typically machined from graphite blocks/plates with strong corrosion resistance, no gas permeability and good electrical conductivity. The flow field channels are machined into the surfaces on both sides of the bipolar plate. The layout of these channels in the bipolar plate determines the uniformity of distribution of the reactants onto the electrode surface, thus the plates can be very complex. Therefore, manufacture of bipolar plates is difficult and expensive.

In addition, when a bipolar flow field plate is made of metal or graphite, a leak current sometimes runs in the bipolar plate across the fluids and electrodes, causing corrosion to occur in the bipolar plate. It has been difficult to manufacture a bipolar plate for polymer electrolyte fuel cells from a single material that exhibits a high degree of resistance to the corrosive fluids, has good current collection properties and a high degree of structural integrity.

In order to form a bipolar fuel cell stack, a group of bipolar plate assemblies are connected in series where each plate supports two gas electrodes, an anode on one side and a cathode on the opposite side. Such a fuel cell stack (maybe comprising 50 or more plates) becomes functional only after introducing reactants to the whole stack. That is, the fuel cell stack is capable of generating electric current only when an appropriate fuel such as H₂ and O₂ is passed through the stack interior.

While the bipolar fuel cell stack assembly procedure appears uncomplicated, there are many practical manufacturing and assembly problems associated with this conventional fuel cell bipolar design. The major problem is that the fuel cell stack can only be tested after it has been completely assembled. In a large stack, the likelihood that each individual fuel cell performs within specification is very poor. Accordingly, in the case of a failure, for example poor operating cell voltage, the entire stack must be dismantled and the faulty cell removed and replaced. Identifying the faulty cell is a cumbersome procedure because the stack normally contains dozens of fuel cells. In addition, the re-assembly of the stack is as difficult and presents no guarantee that all cells will be functioning after re-assembly. Accordingly, a second or third iteration may be required before the stack performs as specified. Moreover, other problems can develop once the stack is in operation. For example, seals separating the fuel from the oxygen can develop leaks. If this occurs, dismantling and re-assembly of the entire stack is again required.

In summary, bipolar fuel cell stacks are expensive to assemble, the assembly process is slow and very labor intensive, and control of product quality is difficult to achieve. The cost of manufacture of individual fuel cell and stack components is further increased by the relatively inefficient way in which cell components must currently be assembled into the full stack.

It is therefore apparent that there is a need for a fuel cell design that can achieve enhanced energy and power densities while satisfactorily addressing the diverse problems in assembly and design identified above. More particularly, there exists a substantial need for a fuel cell design composed of modular components that can be assembled in an automated, reliable fashion, and independently removed when required and that achieve a well-functioning cell in a cost-effective manner.

In addition, there is a need for fuel cells that can be pre-tested prior to assembly into full fuel cell stacks. This pre-testing would identify and eliminate malfunctioning cells prior to final assembly of the stack.

### SUMMARY OF THE INVENTION

Accordingly, in one aspect of the present invention, there is provided a modular, unitized electrochemical fuel cell cartridge, comprising:
(a) a mono-polar anode plate having a first flow field formed in a surface thereof for distributing fuel, at least one fuel opening in communication with the flow field, and at least one fuel outlet in communication with the flow field at the opposing end of the flow field from the at least one fuel opening, and at least one air opening;
(b) a mono-polar cathode plate having a second flow field formed in a surface thereof for distributing air, at least one air opening in communication with the second flow field, and at least one air outlet in communication with the flow field at the opposing end of the flow field from the air opening, and at least one fuel opening; and
   the plates further comprising sealing ridges on one side of the plate and corresponding mating grooves on another side of the plate for providing a plate to plate seal;
(c) a solid polymer membrane electrode assembly operably interposed between the anode and cathode plates.

In a further aspect, the present invention also provides an electrochemical fuel cell module comprising
one or more fuel cell cartridges comprising
   a mono-polar anode plate having a first flow field formed in a surface thereof for distributing fuel, at least one fuel opening in communication with the flow field, and at least one fuel outlet in communication with the flow field at the opposing end of the flow field from the at least one fuel opening, and at least one air opening;
   a mono-polar cathode plate having a second flow field formed in a surface thereof for distributing air, at least one air opening in communication with the second flow field, and at least one air outlet in communication with the flow field at the opposing end of the flow field from the air opening, and at least one fuel opening; and
   the plates further comprising sealing ridges on one side of the plate and corresponding mating grooves on another side of the plate for providing a plate to plate seal;
   a solid polymer membrane electrode assembly operably interposed between the anode and cathode plates;
the at least one fuel openings being aligned in the module such that a fuel feed channel is formed for distributing fuel therethrough;
the at least one air openings being aligned in the module such that an air feed channel is formed for distributing air therethrough;
the at least one fuel outlets being aligned in the module such that a fuel exhaust channel is formed therethrough; and
the at least one air outlets being aligned in the module such that an air exhaust channel is formed therethrough;

In a further aspect, the present invention also provides an electrochemical fuel cell stack comprising
one or more fuel cell cartridges comprising
   a mono-polar anode plate having a first flow field formed in a surface thereof for distributing fuel, at least one fuel opening in communication with the flow field, and at least one fuel outlet in communication with the flow field at the opposing end of the flow field from the at least one fuel opening, and at least one air opening;
   a mono-polar cathode plate having a second flow field formed in a surface thereof for distributing air, at least one air opening in communication with the second flow field, and at least one air outlet in communication with the flow field at the opposing end of the flow field from the air opening, and at least one fuel opening; and
      the plates further comprising sealing ridges on one side of the plate and corresponding mating grooves on another side of the plate for providing a plate to plate seal;
      a solid polymer membrane electrode assembly operably interposed between the anode and cathode plates;
   the at least one fuel openings being aligned in the stack such that a fuel feed channel is formed for distributing fuel therethrough;
   the at least one air openings being aligned in the stack such that an air feed channel is formed for distributing air therethrough;
   the at least one fuel outlets being aligned in the stack such that a fuel exhaust channel is formed therethrough;
   the at least one air outlets being aligned in the stack such that an air exhaust channel is formed therethrough;
   a pair of current collectors, each collector being disposed at opposing external faces of the one or more fuel cell cartridges;
   a first and a second end plate, individually disposed on opposing sides of the current collectors from the one or more fuel cell cartridges, the first end plate having an air inlet in communication with the air feed channel and a fuel inlet in communication with the fuel feed channel and the second end plate having an air outlet in communication with the air exhaust channel and a fuel outlet in communication with the fuel exhaust channel.

### BRIEF DESCRIPTION OF THE DRAWINGS

The preferred embodiments of the present invention will be described with reference to the accompanying drawings in which like numerals refer to the same parts in the several views and in which:

FIG. 1 illustrates an expanded view of the construction of a preferred embodiment of the fuel cell cartridge of the present invention;

FIG. 2 is a partial view of two of the fuel cell cartridges shown in FIG. 1, to illustrate cell-to-cell sealing;

FIG. 3 illustrates an expanded view of a preferred embodiment of the electrochemical fuel cell stack of the present invention; and

FIG. 4 illustrates the performance of a 500 W Fuel Cell Stack Module made according to embodiment depicted in FIG. 1.

FIG. 5 shows the voltage distribution profile of the Stack module at constant current

### DETAILED DESCRIPTION OF THE INVENTION

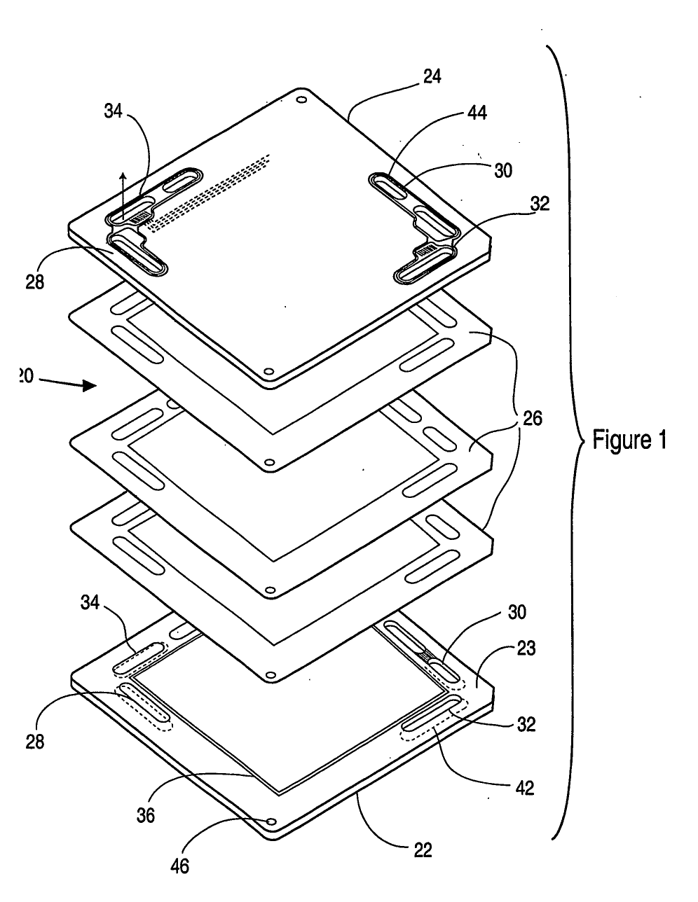

The present invention provides a new design for a modular unitized electrochemical fuel cell cartridge and electrochemical fuel cell stack, and will now be described with reference to FIG. 1.

In one aspect the present invention provides a modular unitized electrochemical fuel cell cartridge designated generally at 20 comprising a monopolar anode plate 22, a monopolar cathode plate 24 and a solid polymer membrane electrode assembly 26 operably interposed between the anode plate 22 and the cathode plate 24. The monopolar anode plate 22 has a first flow field 36 formed in an inwardly facing surface 23 for distributing fuel. A fuel opening 28 (more may be provided) is located at the periphery of the flow field 36 in communication with the flow field 36 via port means known in the art. The monopolar anode plate 22 also comprises a fuel outlet 30 (more may be provided) in communication with the flow field 36, via known port means, and located at the opposite end of the flow field 36 (at its periphery) from the fuel opening 28. The anode plate 22 also has an air opening 32 and an air outlet 34.

The cathode plate 24 also comprises a flow field 37 (not shown) which may be of the same or different configuration as the anode flow field 36, formed in the inwardly facing surface for distributing air and an air opening 32 that is in communication with the flow field 37. The cathode plate 24 also has an air outlet 34 in communication with the flow field 37 and located at the opposite end of the flow field 37 (at its periphery) from the air opening 32. The cathode plate 24 also has a fuel opening 28 and a fuel outlet 30. These openings 28, 30, 32 and 34 are located in the plates 22, 24 such that upon alignment of the plates, channels are formed in the cartridge 20.

Both the anode plate 22 and the cathode plate 24 are substantially planar and in the preferred embodiment are square shaped, however the plates 22, 24 can be any other suitable configuration or size. The plates 22, 24 of the present invention may be integrally formed from a base substrate that is electrically conductive or they may be formed so that the periphery of the flow-field is formed separately and may comprise an electrically insulating thermally conductive polymeric frame. The presence of such a frame may prevent possible short circuiting of adjacent fuel cells and reduce or eliminate parasitic current flow between adjacent fuel cells.

The frame may also improve the heat management of the fuel cell cartridge. Additionally the incorporation of the frame provides a built in safety feature for protecting persons from possible contact with electrically live parts of the fuel cell cartridge 20.

The plates 22, 24 of the present invention may be manufactured from any material that is suitable for an electrochemical fuel cell plate, as is known in the art.

The anode plate 22 and the cathode plate 24 of the present invention are relatively thin and typically of a thickness between 0.015 to 0.12 inches (0.038 to 0.30 cm), however variations on this thickness may occur depending on the requirements of the plates 22, 24 and their use.

As previously mentioned each of the plates 22, 24 contain a flow field 36, 37 on their inwardly facing surfaces. In a preferred embodiment of the present invention the flow field 36 is located in the central portion of the plates 22, 24. The flow field 36 has a network of reactant flow channels (not clearly discernable in the Figures) that distribute reactants over the surface of the plates 22, 24.

Fuel openings 28 are in fluid communication with the flow fields 36, 37. As shown in FIG. 1 the fuel openings 28 located on the anode plate 22 of the preferred embodiment of the present invention is located at the periphery of the plate 22, however the fuel opening 28 can be located on any position on the plate 22 providing it is in fluid communication with the flow field 36 located on the plate 22. At the opposing end of the flow field 36 from the fuel opening 28 there is located a fuel outlet 30 that extends through the anode plate 22. In the present invention the fuel outlet is located around the periphery of the plate 22. The cathode plate 24 comprises an air opening 32 and an air outlet 34, both of which are in fluid communication with the flow field 37 located on the cathode plate 24 and extend through the plate 24. The anode plate 22 also comprises at least one air opening 32 that is located through the plate 22 but is not in fluid communication with the flow field 36. Similarly the cathode plate 24 comprises a fuel opening 28 that is located through the plate 24 but is not in fluid communication with the flow field 36 located on the plate 24.

As can be seen from FIG. 1, the anode plate 22 has a series of sealing ridges 42 located on the outwardly facing surface of the plate 22 that does not contain the flow field 36, and the cathode plate 24 comprises a series of corresponding mating grooves 44 located on the outwardly facing surface that does not contain the flow field 37. The ridges 42 and the grooves 44 provide a cartridge-to-cartridge, also referred to as a cell-to-cell seal between the anode plate 22 and the cathode plate 24 when they are adjacent and aligned with each other. The ridges 42 and the grooves 44 ensure that there is a tight seal between the cartridges 20 to ensure efficient working of the fuel cell cartridge. The ridges 42 and the grooves 44 of the present invention are located around the periphery of the fuel openings 28, fuel outlets 30, air openings 32 and air outlets 34, however the ridges 42 and the grooves 44 can be located anywhere on the surface of the plate that will ensure efficient sealing between adjacent plates. The ridges 42 are preferably flexible or are provided with an elastomeric coating for creating an adequate seal. The ridges 42 are dimensioned for a tight fit within the mating grooves 44, thereby effecting a seal around each opening 28, 32. The ridges 42 and the grooves 44 provide a means to align cells within stack.

Each of the plates 22, 24 also comprise alignment means 46 to ensure correct alignment of the plates 22, 24 when forming a fuel cell cartridge 20. The alignment means 46 of the present invention preferably comprises a pin integrally formed within each plate 22, 24. The pin aligns with a recess located on the adjacent plate with which a cartridge 20 is formed. Other alignment means may also be used, an example of an alternative alignment means is a series of recesses located through the plates and a series of pins not integrally formed with the plate that can be slotted through the openings when the plates are aligned, other alignment means known in the art may also be used. The pins are made from non-conductive material.

The incorporation of the alignment means 46 on the plates 22, 24 not only ensures correct alignment of the plates 22, 24 but also improves the plate to plate sealing and therefore inhibits intra-cell leaking. As previously discussed, the preferred embodiment of the present invention utilizes integrated pins within the plate design as the alignment means 46. By integrally forming the alignment means 46 within the plate the cost of the plate and the manufacturing time is significantly reduced. The plate, and subsequently when in use, the cartridge has less components which reduces the complexity of the plate and cartridge. The incorporation of the ridges 42 and corresponding mating grooves 44 on the external surfaces of the plates 22, 24 also ensure the alignment of adjacent plates 22, 24 and consequently fuel cell cartridges 20 and also assists in inhibiting inter-cell leaking.

The fuel cell cartridge 20 of the present invention may further comprise one or more adhesive film gaskets (not shown). Each plate 22, 24 may be bonded to a film gasket, and the solid polymer membrane electrode assembly 26 subsequently sandwiched between the plates 22, 24 and bonded to them by such gaskets.

Alternatively, a sealant or bondweld may be used to connect the plates and membrane electrode assembly and form inter-cell seal. Sealant may be applied using fluid dispensing systems. This process reduces or eliminates the laborious assembly and alignment issues encountered with bipolar plate designs. This design also enables a simple and fast quality control and maintenance of the fuel cell units.

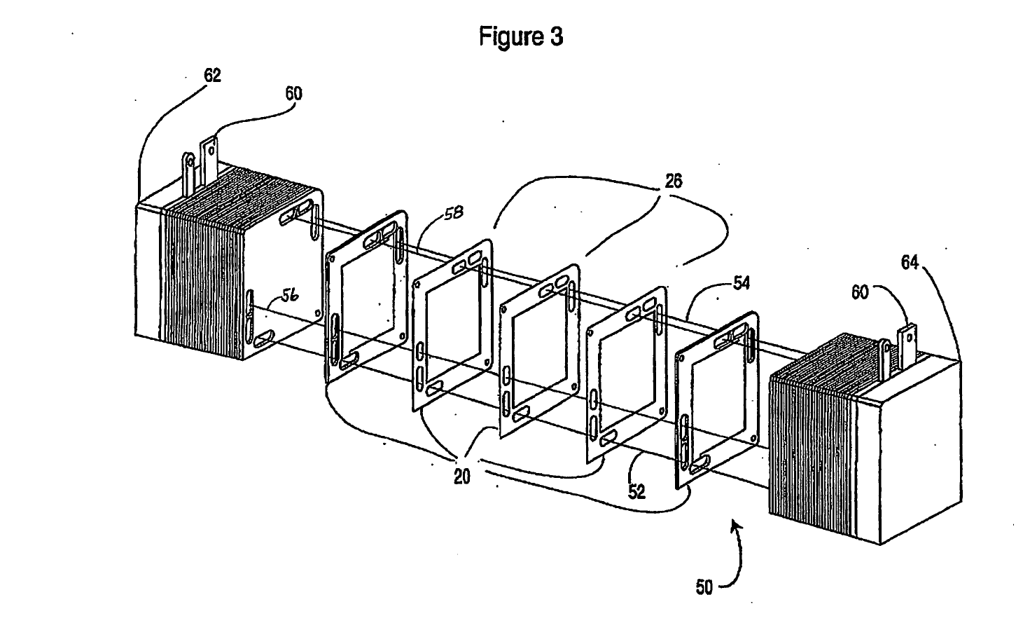

As can be seen in FIG. 1 and FIG. 3, when the membrane electrode assembly 26 is of a similar dimension to the plates 22, 24 it is necessary for the membrane electrode assembly to contain openings 28, 30, 32 and 34 that are of the same dimensions and will be aligned with those located in the plates 22, 24 in order that fuel and air may flow through respective openings and that the membrane electrode assembly does not inhibit the flow of fuel through the fuel channel 52, shown in FIG. 3, or air through the air channel 54, shown in FIG. 3. However the membrane electrode assembly 26 may be manufactured to be of a smaller dimension than the plates 22, 24 and therefore not intefer with the openings 28, 30, 32 and 34 and therefore in such a case the membrane electrode assembly would not require identical openings.

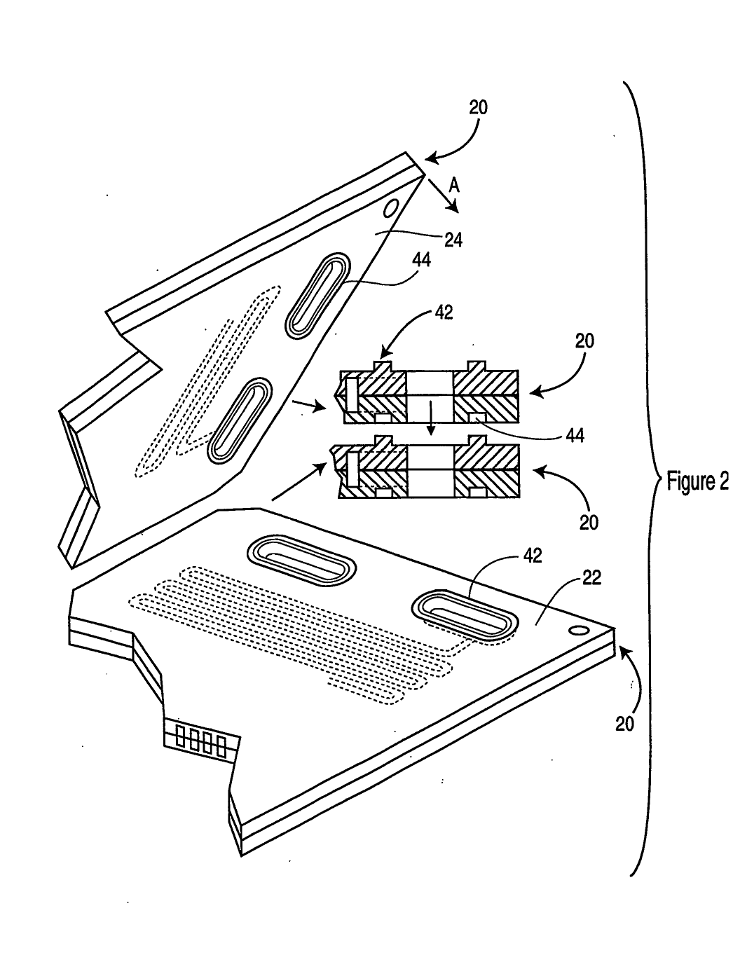

Referring now to FIG. 2 the cartridge-to-cartridge seal, also commonly referred to as the cell-to-cell seal, will be described in more detail. As previously mentioned the outer surface of the anode plate 22 has ridges 42 whereas the outer surface of the cathode plate 24 has corresponding mating grooves 44. When two cartridges 20 are aligned with each other, in the direction of arrow A for example, the anode plate 22 of one being aligned adjacent the cathode plate 24 of another, the ridges 42 are received within the grooves 44 and provide a cartridge-to-cartridge seal. In order to remove a cartridge 20 either from a stack or from an adjacent cartridge, the cartridges are simply pulled apart, in the opposite direction to arrow A, and the ridges 42 are released from the grooves 44. It is also possible to integrate sealing ridges 42 and mating grooves 44 on the inner surface of the anode and cathode plates 22, 24 for intra-cell seal.

These cartridges 20 allow easy assembly and maintenance, flexible arrangement and use, and can be used in a wide range of applications.

A further aspect of the present invention, shown in FIG. 3, provides an electrochemical fuel cell stack 50 comprising one or more fuel cell cartridges 20, previously described. When located in the fuel cell stack 50 the fuel openings 28 are aligned in order to form a fuel feed channel 52 for distributing fuel through the stack 50, and the air opening 32 are aligned in the stack 50 in order to form an air feed channel 54 for distributing air through the stack 50. Similarly the one or more fuel outlets 30 are aligned in the stack 50 to form a fuel exhaust channel 56, and the one or more air outlets 34 are aligned in the stack 50 in order to form an air exhaust channel 58. The fuel cell stack 50 also includes a pair of current collectors 60 that are located at opposing external faces of the one or more fuel cell cartridge 20. Located on opposing sides of the current collector 60 there is located a first end plate 62 and a second end plate 64 located at the opposing end from the first end plate 62. The first end plate 62 has an air inlet port, not shown, that is in communication with the air feed channel 54 and a fuel inlet port, not shown, that is in communication with the fuel feed channel 52. The second end plate 64 has an air exhaust, not shown, that is in communication with the air exhaust channel 58 and similarly a fuel exhaust, not shown, that is in communication with a fuel exhaust channel 56.

As can be seen in FIG. 3 when more than one fuel cell cartridge 20 is located in the stack 50 the fuel cell cartridges 20 are aligned with alternating anode plates 22 and cathode plates 24. The ridges 42 and corresponding mating grooves 44 ensure efficient plate to plate sealing between adjacent fuel cell cartridges 20 while the internal alignment means 46 ensures efficient sealing and alignment of each individual fuel cell cartridge 20.

The assembly of the fuel cell cartridge will now be discussed. The fuel cell cartridge 20 resembles a sandwich structure comprising a mono-polar flow field anode plate 22, a solid polymer membrane electrode assembly 26 and a mono-polar flow field cathode plate 24.

The process for assembling the fuel cell cartridge 20 may be automated using well-known combinations of conveyor, dispenser and pressure seal mechanisms (not shown). The fuel cell 20 assembly conveyor receives all cell components in succession from a component dispenser having a component feeder/loader and conveys the components through adhesive film, or adhesive gasket dispensing station located along the conveyor path. The conveyor operates intermittently to transport the cell components to a station where it is pressure bonded to form the fuel cell cartridge 20, which is then transferred to a single cell dispenser. The single cell dispenser includes a quality control station and a cell dispensing mechanism, which dispenses and counts cells one by one. After this, the individual fuel cell cartridges are stacked in alternating fashion with fuel cells of opposite polarity connected in series until the desired number of fuel cells have been achieved. The fuel cells are then aligned by vibrating the stack. After alignment, the stack is placed into a stack holder.

The manufactured fuel cell cartridges 20 may first be tested at a quality control station along the production line. At this station, a number of test methods and tools may be used to test the quality of the individual fuel cell cartridges. These include electrochemical methods, such as open circuit potential measurements and polarization techniques, and alternating current (AC) resistance methods. An AC milliohmmeter provides a practical tool for testing the quality of each of the individual fuel cells by measuring its internal resistance. Faulty cells will be eliminated prior to assembly in the stack. This pre-testing capability significantly improves stack productivity and reliability.

The assembly of the stack 50 will now be discussed with reference to a fuel stack containing more than one fuel cartridge 20, however the stack can contain only one fuel cell cartridge 20 and would be assembled in a similar manner to that which is described. The fuel cartridges 20 are arranged in series so that the outer surface of the anode plate 22 of one cartridge abuts the outer surface of the cathode plate 24 of an adjacent cartridge 20. The ridges located 42 located on the outer surface of the anode plate 22 are releasably received in the mating grooves 44 located on the outer surface of the cathode plate 24 and provide a sound cartridge-to-cartridge seal. When the cartridges 20 are aligned in series the fuel openings 28 located on the plates 22, 24 are all aligned and form a fuel feed channel 52, likewise the fuel outlets 30 are aligned and form a fuel exhaust channel 56, the air openings 32 are aligned and form an air feed channel 54 and the air outlets 34 are aligned and form an air exhaust channel 58.

Once the cartridges 20 are aligned in series, a current collector 60 is placed at each end of the series of cartridges 20 in parallel with the surface of the cartridges 20. The current collectors 60 of the present invention are preferably made from copper. Gold plating may be used to improve corrosion resistance of the copper current collector. After addition of the current collectors 60, a first end plate 62 is placed at one end of the cartridges 20 and a second end plate 64 is placed at the opposite end.

The first end plate 62 contains an air inlet port 66 and a fuel inlet port 68 and when placed at the end of the stack the air inlet port 66 is aligned with the air feed channel 54 and allows air to flow through the air inlet port 66 and into the air feed channel 54 and through the flow fields 36 that are in fluid communication with the air feed channel 54. Likewise the fuel inlet port 68 is aligned with the fuel feed channel 52 and allows fuel to flow through the fuel inlet port 68 into the fuel feed channel 52 and through the flow fields 36 that are in fluid communication with the fuel feed channel 52.

At the opposing end of the stack, the second end plate 64 contains an air exhaust, not shown, and a fuel exhaust, not shown. In a similar configuration to the first end plate 62, the air exhaust of the second end plate 64 is aligned with the air outlet channel 58 and allows the air that flows through the flow fields 36 and out of the air outlets 34 to pass through the air outlet channel 58 and out of the air exhaust. Similarly the second end plate 64 also has a fuel exhaust, not shown, that is aligned with the fuel outlet channel 56 and allows the fuel that flows through the flow fields 36 and out of the fuel outlets 30 to pass through the fuel outlet channel 56 and out of the fuel exhaust.

Further details of the preferred embodiment of the present invention will now be illustrated in the following example that is understood to be non-limiting with respect to the appended claims.

### EXAMPLE 1

Modular, unitized electrochemical fuel cell cartridges were designed and constructed for a 500 W fuel cell stack module in general accordance with the embodiment depicted in FIG. 1. The Stack comprised 40 cartridges and was designed to be operated using methanol fuel and air as oxidant. Each cartridge consisted of two monopole plates and membrane electrode assembly (MEA). The MEA included a proton exchange membranes such as Nafion®—DuPont, a catalytic material such as platinum, platinum-ruthenium alloys, and porous diffusion backing/layers. The diffusion layer (DL) was edge sealed by impregnating its perimeter with a thermoplastic fluoropolymer. The MEA was formed by hot pressing the edge-sealed DL against the membrane. The manifold holes were cut in the same pressing step. The MEA consumed the fuel and oxidant through the electrochemical processes and produced an electrical current, which was drawn from the electrodes to the external circuit. The plates were made of conductive composites. The flow-field channels were milled in one side of the plate and the seal ridges or grooves on the opposite side. The cell cartridge was fabricated by simply sandwiching the MEA between the two plates. Teflon pins were used to secure the cartridge. The cartridge AC resistance was measured using milliohm meter or AC impedance to check the quality of the cell.

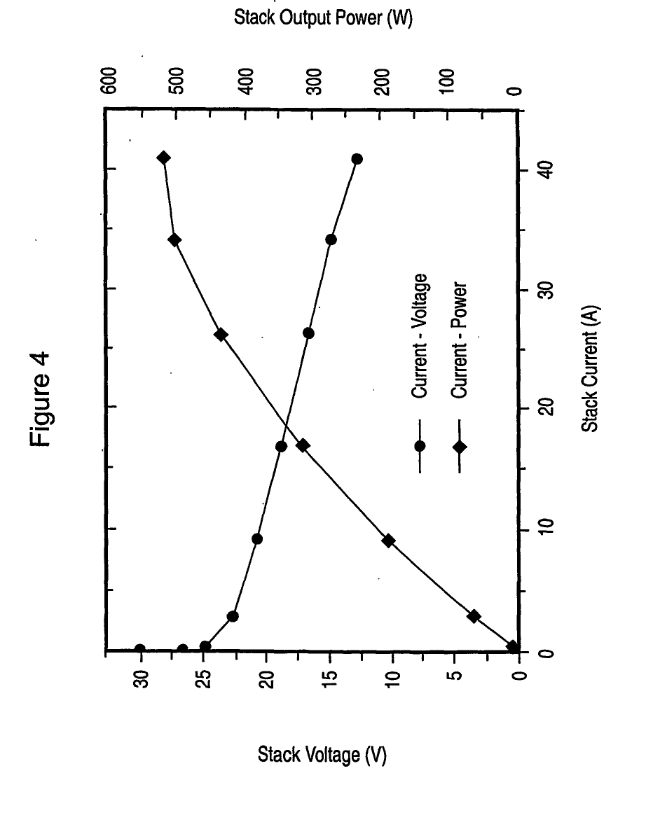

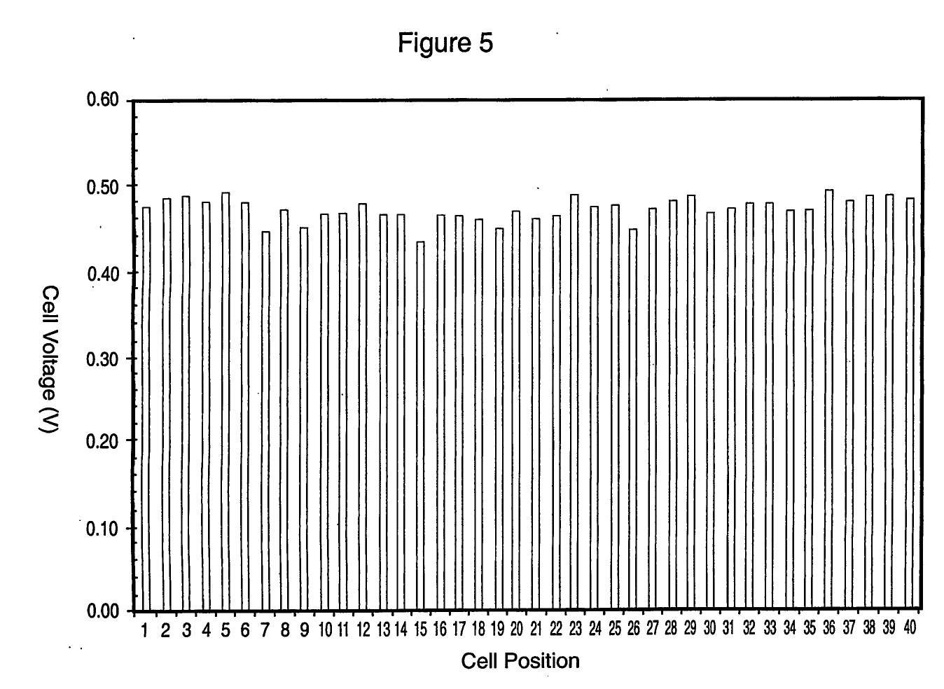

A dielectric one-sided adhesive material was placed on the endplate. The bus bar was secured to the endplate using Nylon screws. A seal between the endplate-bus bar subassembly and cell cartridge was established using o-rings. The stack was fabricated using an assembly rig with alignment guides. The first endplate-bus bar subassembly was laid down. The unitized cell cartridges were placed over the subassembly until the desired number of cells is assembled. The ridges and grooves ensure proper cell-to-cell alignment and establish cell-to-cell seal. The stack was clamped to the desired pressure and the resistance of the stack was measured. Pneumatic leak test using air or helium was performed. The current-voltage performance and steady state operation of the stack was evaluated. FIG. 4 shows the current-voltage behavior of the Stack operated at 80 deg. C. The cell voltage distribution of the 500 W Direct Methanol Stack module at 20 A is shown in FIG. 5.

Although the present invention has been shown and described with respect to its preferred embodiments, it will be understood by those skilled in the art that other changes, modifications, additions and omissions may be made without departing from the substance and the scope of the present invention as defined by the attached claims.

1. A modular, unitized electrochemical fuel cell cartridge, comprising:
(a) a mono-polar anode plate having a first flow field formed in a first inwardly facing surface thereof for distributing fuel, at least one fuel inlet opening in communication with the flow field, and at least one fuel outlet in communication with the flow field at the opposing end of the flow field from the at least one fuel opening, and at least one air opening;
(b) a mono-polar cathode plate having a second flow field formed in a first inwardly facing surface thereof for distributing oxidant, at least one air inlet opening in communication with the second flow field, and at least one air outlet in communication with the flow field at the opposing end of the flow field from the air opening, and at least one fuel opening;
the plates further comprising first sealing ridges on one inwardly facing surface of one of the plates and first corresponding mating grooves on one inwardly facing surface of the other plate for providing a plate to plate seal;
(c) a solid polymer membrane electrode assembly operably interposed between the anode and cathode plates; and
(d) the plates further comprising second sealing ridges on an outwardly facing surface of one of the plates and second corresponding mating grooves on an outwardly facing surface of the other plate for providing a cell-to-cell seal,
wherein the first and second sealing ridges and the first and second corresponding mating grooves are located around the periphery of the air inlet openings, the air outlets, the fuel inlet openings and the fuel outlets.

2. The fuel cell cartridge of claim 1, wherein the first mono-polar plate and the second monopolar plate comprise a base substrate which is electrically conductive

3. The fuel cell cartridge of claim 1, wherein the first mono-polar plate and the second mono-polar plate comprise
(a) an electrically-insulating, thermally-conductive frame comprising a first polymeric material; and
(b) a central, electrically conductive planar portion within the frame, the central portion comprising a second polymeric material and containing the flow field thereon;
wherein the first and second polymeric materials have similar mechanical, thermal and melt flow properties.

4. The fuel cell cartridge of claim 3, wherein the frame and the central planar portion are molded together to form the mono-polar plate.

5. The fuel cell cartridge of claim 4, wherein the frame and central planar portion are bonded together with a polymeric binder comprising a common polymer component present in both the first and second polymeric materials.

6. The fuel cell cartridge of claim 2, wherein the openings are located at the periphery of the plates.

7. The fuel cell cartridge of claim 6, wherein the plates further comprise alignment means for aligning adjacent plates.

8. The fuel cell cartridge of claim 7, wherein the alignment means is a pin that is integrally formed in the plate.

9. The fuel cell cartridge or claim 8, wherein the alignment means is an aperture located through the plate and a pin that is locatable through the apertures on adjacent plates.

10. The fuel cell cartridge of claims 1, further comprising:
(a) a first sealing adhesive film gasket interposed between the anode and one side of the solid polymer membrane electrode assembly; and
(b) a second sealing adhesive film gasket interposed between the cathode and another side of the solid polymer membrane electrode assembly.

11. An electrochemical fuel cell module, comprising:
one or more fuel cell cartridges comprising
a mono-polar anode plate having a first flow field formed in a first inwardly facing surface thereof for distributing fuel, at least one fuel opening in communication with the flow field, and at least one fuel outlet in communication with the flow field at the opposing end of the flow field from the at least one fuel opening, and at least one air opening:
a mono-polar cathode plate having a second flow field formed in a first inwardly surface thereof for distributing air, at least one air opening in communication with the second flow field and at least one air outlet in communication with the flow field at the opposing end of the flow field from the air opening, and at least one fuel opening;
the plates further comprising first sealing ridges on one inwardly facing surface of one of the plates and first corresponding mating grooves on one inwardly facing surface of the other plate or providing a plate to plate seal;
a solid polymer membrane electrode assembly operably interposed between the anode and cathode plates; and
the plates further comprising second scaling ridges on an outwardly facing surface of one of the plates and second corresponding mating grooves on an outwardly facing surface of the other plate for providing a cell-to-cell seal,
the at least one fuel openings being aligned in the module such that a fuel feed channel is formed for distributing fuel therethrough;
the at least one air openings being aligned in the module such that an air feed channel is formed for distributing air therethrough;
the at least one fuel outlets being aligned in the module such that a fuel exhaust channel is formed therethrough;
the at least one air outlets being aligned in the module such that an air exhaust channel is formed therethrough; and
wherein the first and second sealing ridges and the first and second corresponding mating grooves are located around the periphery of the air inlet openings, the air outlets, the fuel inlet openings and the fuel outlets.

12. The electrochemical fuel cell module according to claim 11, wherein the openings are located at the periphery of the plates.

13. The electrochemical fuel cell module according to claim 12, wherein the plates further comprise alignment means for aligning adjacent plates

14. The electrochemical fuel cell module according to claim 13, wherein the alignment means is a pin that is integrally formed in the plate.

15. The electrochemical fuel cell module according to claim 14, wherein the alignment means is an aperture located through the plate and a pin that is locatable through the apertures on adjacent plates

16. An electrochemical fuel cell stack, comprising a plurality of fuel cell cartridges of claim 1.

17. An electrochemical fuel cell stack comprising
one or more fuel cell cartridges comprising
a mono-polar anode plate having a first flow field formed in a first inwardly facing surface thereof for distributing fuel, at least one fuel opening in communication with the flow field, and at least one fuel outlet in communication with the flow field at the opposing end of the flow field from the at least one fuel opening, and at least one air opening;
a mono-polar cathode plate having a second flow field formed in a first inwardly facing surface thereof for distributing air, at least one air opening in communication with the second flow field, and at least one air outlet in communication with the flow field at the opposing end of the flow field from the air opening, and at least one fuel opening;
the plates further comprising first sealing ridges on one inwardly facing surface of one of the plates and first corresponding mating grooves on one inwardly facing surface of the other plate for providing a plate to plate seal, wherein the first scaling ridges and the first corresponding mating grooves are located around the periphery of the air inlet openings, the air outlets, the fuel inlet openings and the fuel outlets; and
a solid polymer membrane electrode assembly operably interposed between the anode and cathode plates;
the at least one fuel openings being aligned in the stack such that a fuel feed channel is formed for distributing fuel therethrough;
the at least one air openings being aligned in the stack such that an air feed channel is formed for distributing air therethrough;
the at least one fuel outlets being aligned in the stack such that a fuel exhaust channel is formed therethrough;
the at least one air outlets being aligned in the stack such that an air exhaust channel is formed therethrough;
a pair of current collectors, each collector being disposed at opposing external faces of the one or more fuel cell cartridges;
a first and a second end plate, individually disposed on opposing sides of The current collectors from the one or more fuel cell cartridge, the first end plate having an air inlet in communication with the air feed channel and a fuel inlet in communication with the fuel feed channel and the second end plate having an air outlet in communication with the air exhaust channel and a fuel outlet in communication with the fuel exhaust channel.

18. An electrochemical fuel cell stack according to claim 17, comprising one or more fuel cell cartridges the one or more cartridges being positioned in the stack in abutting relation with alternating anode and cathode plates.

19. The electrochemical fuel cell stack according to claim 17, wherein the plates further comprise second scaling ridges on an outwardly facing surface of one of the plates and corresponding second mating grooves on an outwardly facing surface of the other plate for providing a cell-to-cell seal, wherein the second sealing ridges and the second corresponding mating grooves are located around the periphery of the air inlet openings, the air outlets, the fuel inlet openings and the fuel outlets.

20. The electrochemical fuel cell stack according to claim 19, wherein the openings are located at the periphery of the plates.

21. The electrochemical fuel cell stack according to claim 20, wherein the plates further comprise alignment means for aligning adjacent plates.

22. The electrochemical fuel cell stack according to claim 21, wherein the alignment mean is is a pin that is integrally formed in the plate.

23. The electrochemical fuel cell stack according to claim 22, wherein the alignment means is an aperture located through the plate and a pin that is locatable through the apertures on adjacent plates.
